(19) United States
(12) Patent Application Publication
(10) Pub. No.: US 2007/0078194 A1
(43) Pub. Date: Apr. 5, 2007

(54) Flexographic printing plate and flexographic printing plate precursor composition for preparing same

(76) Inventor: David John St. Clair, Houston, TX (US)

Correspondence Address: KRATON POLYMERS U.S. LLC, WESTHOLLOW TECHNOLOGY CENTER, 3333 HIGHWAY 6 SOUTH, HOUSTON, TX, 77082, US

(21) Appl. No.: 11/243,203

(22) Filed: Oct. 4, 2005

(51) Int. Cl. C08F 2/50

(52) U.S. Cl. 522/6; 525/242

(57) ABSTRACT

A flexographic printing plate precursor composition which includes a block copolymer of a mono alkenyl arene and a conjugated diene, a plasticizer, a crosslinker and a photoinitator. Specifically, the block copolymer is an unsaturated block copolymer having a mono alkenyl arene content of equal to or greater than 60 weight percent and a modulus of less than 125,000 psi. The plasticizer is an aromatic ester or a liquid aromatic resin. The printing plate which is the UV light-initiated crosslinked product of the precursor composition has improved ozone and abrasion resistance.

### FIELD OF THE INVENTION

The present invention is directed to a flexographic printing plate and a flexographic printing plate precursor (FPPP) composition for preparing the same. More particularly, the present invention is directed to a flexographic printing plate and a FPPP composition which includes a block copolymer of a mono alkenyl arene and a conjugated diene. The block copolymer of the present invention is an unsaturated block copolymer having a high monoalkenyl arene content and a modulus of less than 125,000 psi.

### BACKGROUND OF THE INVENTION

Flexographic printing plates are well known in the art and are especially useful for printing on diverse products such as flexible plastic containers, cartons, plastic bags, boxes, envelopes and the like. For the purpose of the present invention, uncured photo-curable polymeric compositions useful in preparing cured flexographic printing plates will be referred to hereinafter as flexographic printing plate precursor (FPPP) compositions. FPPP compositions include a photo-cured layer prepared from a photo-curable polymer composition and a protective layer to protect the photo-curable layer from daylight. Optionally, the FPPP composition also includes a support. A support is used to impart strength to the FPPP composition.

Alternatively, the side of the FPPP composition opposite the image (printing) side is cured to form a support. Typically, in the absence of a support, a flexographic printing plate is prepared by first curing the side of the photo-curable layer of the precursor opposite the printing side. As a result, that side of the photo-curable layer crosslinks, becomes a substantially insoluble photoset layer and acts as a support for the uncured remainder of the precursor. Subsequently, the printing side is selectively cured by exposing the photo-curable layer image-wise to light, e.g., ultraviolet (UV) light. The unexposed, and thus uncured, parts of the layer are then removed in developer baths, e.g., with a solvent or water. After drying, the flexographic printing plate is ready for use.

Printing plates must be soft and elastic after curing. Normally, elasticity is obtained by the presence of an elastomer in the photo-curable polymer composition. Often, the elastomer is a block copolymer having two or more polymerized styrene blocks and one or more polymerized conjugated diene blocks.

The FPPP composition must be easy and quick to cure, and the uncured material must be easy to remove. In addition, the FPPP composition is preferably not tacky. The flexographic printing plate must be dimensionally stable during storage, flexible enough to wrap around a printing cylinder, strong enough to withstand the rigors experienced during a printing process, abrasion resistant, soft enough to facilitate ink transfer during the printing process, and resistant enough to the particular ink solvent to avoid blurring of the image. It is appreciated that the achievement of an attractive balance of all these physical properties is difficult.

Although the use of block copolymers has proven to provide many of these properties, block copolymers of a mono alkenyl arene and a conjugated diene often degrade under ozone attack. That is, ozone is generated by lamps utilized in the UV curing of printing inks. This ozone attacks unsaturated conjugated diene blocks which, in the printing plates of the prior art, constituted a high weight percent of the block copolymer. Indeed, block copolymers employed as flexographic printing plates constitute a greater weight percent of conjugated diene than mono alkenyl arene.

The explanation of the higher conjugated diene concentration in block copolymers employed as flexographic printing plates in the prior art is the requirement for flexibility which, as stated above, is essential to the successful utilization of flexographic printing plates. Higher concentrations of conjugated diene in the block copolymers employed in this application insure this flexibility.

The above remarks emphasize the need in the art for a new and improved flexographic printing plate and FPPP composition for preparing the same which provides greater resistance to ozone attack without sacrificing the requisite flexibility required of flexographic printing plates.

Another problem associated with printing plates of the prior art, as stated above, is abrasion resistance. Obviously, this property is critical to long term operational use of the printing plate. Again, high conjugated diene concentration in the block copolymer employed in the manufacture of the printing plate significantly contributes to the absence of high abrasion resistance.

It is thus apparent that there is a need in the art for a new and improved flexographic printing plate and a FPPP composition which provides improved ozone resistance and abrasion resistance without compromising the requisite flexibility necessary for the successful utilization as a flexographic printing plate.

### SUMMARY OF THE INVENTION

A new flexographic printing plate and FPPP composition for making the same has now been developed which provides improved ozone and abrasion resistance without compromising the requisite flexibility required of a flexographic printing plate.

In accordance with the present invention, a FPPP composition is provided which includes at least one unsaturated block copolymer that has a high monoalkenyl arene content and a modulus of less than 125,000 psi. The at least one unsaturated block copolymer having the high monoalkenyl arene content and modulus of less than 125,000 psi employed in the present invention will be described in greater detail herein below. Throughout this application, the aforementioned block copolymer can also be referred to as ‘an unsaturated high monoalkenyl arene content block copolymer having a modulus of less than 125,000 psi’.

More specifically, the block copolymers employed in the present invention are unsaturated block copolymers having a monoalkenyl arene (polystyrene) content equal to or greater than about 60 weight percent based on the total weight of the block copolymer and a modulus less than about 125,000 psi. These block copolymers include at least two A blocks and at least one B block, wherein each A block is a mono alkenyl arene homopolymer block and each B block is selected from (a) a polymer block of at least one conjugated diene and at least one mono alkenyl arene and having a random distribution, (b) a polymer block of at least one conjugated diene and at least one mono alkenyl arene and having a blocked distribution; (c) a polymer block of at least one conjugated diene and at least one mono alkenyl arene and having a tapered distribution; and (d) a polymer block of at least one conjugated diene and at least one mono alkenyl arene and having a controlled distribution.

In further accordance with the present invention, a flexographic printing plate is provided. The flexographic printing plate includes the photo-cured FPPP composition of the present invention.

### DETAILED DESCRIPTION OF THE INVENTION

In one aspect of the present invention, a flexographic printing plate precursor (FPPP) composition is provided which comprises:

(i) from about 50% to about 80% of at least one unsaturated (i.e., unhydrogenated) block copolymer;

(ii) from about 10% to about 40% of an aromatic liquid plasticizer;

(iii) from about 5% to about 15% of an acrylic or methacrylic crosslinker; and

(iv) from about 0.5% to about 4% of a photoinitiator, said percentages of components (i), (ii), (iii) and (iv) being by weight, based on the total weight of said flexographic printing plate precursor composition.

Specifically, the block copolymers utilized in the present invention broadly comprise any unsaturated block copolymers that meet the following criteria:

(1) the block copolymer has a mono alkenyl arene content equal to or greater than 60 weight percent, based on the total weight of the block copolymer;

(2) the block copolymer has a modulus less than about 125,000 psi; and

(3) the block copolymer has at least two A blocks and at least one B block
wherein each A block is a mono alkenyl arene polymer block and
wherein each B block is selected from:
   (a) polymer blocks having at least one conjugated diene and at least one mono alkenyl arene and having a random distribution;
   (b) polymer blocks having at least one conjugated diene and at least one mono alkenyl arene and having a blocked distribution;
   (c) polymer blocks having at least one conjugated diene and at least one mono alkenyl arene and having a tapered distribution; and
   (d) polymer blocks having at least one conjugated diene and at least one mono alkenyl arene and having a controlled distribution.

One important aspect of the block copolymers used in preparing the FPPP composition of the present invention is the mono alkenyl arene content. As noted hereinbefore, the mono alkenyl arene content should be equal to or greater than 60 weight percent, based on the total weight of the block copolymer. Preferably, the mono alkenyl arene content will range from about 60 to about 85 weight percent for the block copolymer. In alternative embodiments, the mono alkenyl arene content will range from about 70 to about 80 weight percent, more preferably from about 73 to about 78 weight percent.

Another important aspect of the block copolymers utilized in the present invention is the modulus of the block copolymer. As used herein, the term “modulus” refers to flexural modulus according to ASTM D-790 (Procedure B). This modulus refers to the ratio of stress to strain for a given polymer. The block copolymers used in the present invention will have a modulus of less than about 125,000 psi. The modulus is preferably less than about 115,000 psi and even more preferably less than about 110,000.

The mono alkenyl arenes utilized in the A and B blocks of the block copolymers are independently selected from styrene, alpha-methylstyrene, para-methylstyrene, vinyl toluene, vinylnaphthalene, and para-butyl styrene or mixtures thereof. Of these, styrene is the most preferred.

The conjugated dienes of the block B blocks are independently selected from 1,3-butadiene and substituted butadienes, such as, for example, isoprene, piperylene, 2,3-dimethyl-1,3-butadiene, and 1-phenyl-1,3-butadiene, or mixtures thereof. Of these, isoprene and 1,3-butadiene are the most preferred with 1,3-butadiene being the more preferred of the two.

While a wide range of molecular weights of the block copolymers utilized in the compositions of the present invention can be used, in many instances the number average molecular weight of each A block will independently range from about 5,000 to about 200,000, preferably from about 7,500 to about 150,000, and the number average molecular weight of each B block will independently range from about 10,000 to about 100,000, preferably from about 10,000 to about 75,000, for the sequential block copolymers and from about 5,000 to about 50,000, preferable from about 5,000 to about 37,500, for the coupled block copolymers.

As noted above, the B block(s) of the block copolymers that can be utilized in the present invention are selected from a variety of midblocks. More specifically, within the scope of the contemplated block copolymers are those block copolymers wherein the midblocks are considered to have a distribution configuration that is “random”, “blocked”, “tapered” or “controlled”.

More specifically, in embodiment (a), B comprises a polymer block of at least one conjugated diene and at least one mono alkenyl arene wherein the B block has a random distribution. As used herein, the phrase “random distribution” means that the distribution of monomers from one end of the block to the other end is roughly uniform (e.g., it is a statistical distribution based on the relative concentrations of the monomers). Preferably, in this embodiment, the conjugated diene of each B block is independently selected from isoprene and butadiene, with butadiene being the most preferred, and the mono alkenyl arene is as defined hereinbefore with regard to A, with styrene being the most preferred.

In the second embodiment (b), B comprises a polymer block comprising at least one conjugated diene and at least one mono alkenyl arene, wherein the B block has a blocked distribution. As used herein, the phrase “blocked distribution” means that the distribution is a nonuniform distribution in which the A monomers (or in the alternative the B monomers) are more likely to be grouped with other A monomers (or in the case of the B monomers, with other B monomers) than is found in a statistical (i.e., “random”) distribution thereby resulting in a short “defined” monomer block. Preferably, in this embodiment, the conjugated diene of each B block is also independently selected from isoprene and butadiene with butadiene being the most preferred and the mono alkenyl arene is as defined hereinbefore with regard to A, with styrene being the most preferred.

In the third embodiment (c), B comprises a polymer block comprising at least one conjugated diene and at least one mono alkenyl arene, wherein the B block has a tapered distribution. As used herein, the phrase “tapered distribution” means that the distribution is a nonuniform distribution in which the concentration of A monomer (or in the alternative, B monomer) at one end of the block is greater than at the other end of the block (it gradually declines from one end of the block to the other end of the block). As in the other embodiments, preferably the conjugated diene of each B block is also independently selected from isoprene and butadiene with butadiene being the most preferred and the mono alkenyl arene is as defined hereinbefore with regard to A, with styrene being the most preferred.

In the fourth and final embodiment (d), B comprises a polymer block comprising at least one conjugated diene and at least one mono alkenyl arene, wherein the B block has a controlled distribution. For purposes herein, the phrase “controlled distribution” is as defined in co-pending and commonly assigned U.S. patent application Ser. No. 10/359,981, filed Feb. 6, 2003 and entitled “NOVEL BLOCK COPOLYMERS AND METHOD FOR MAKING SAME”. The entire contents of the 10/359,981 patent application, are thus incorporated herein by reference. More specifically, the molecular structure of the controlled distribution block copolymer has the following attributes: (1) terminal regions adjacent to the mono alkenyl arene homopolymer (“A”) blocks that are rich in (i.e., having a greater than average amount of) conjugated diene units; (2) one or more regions not adjacent to the A blocks that are rich in (i.e., having a greater than average amount of) mono alkenyl arene units; and (3) an overall structure having relatively low mono alkenyl arene, e.g., styrene, blockiness. For the purposes hereof, “rich in” is defined as greater than the average amount, preferably 5% greater than the average amount. As in the other embodiments, preferably the conjugated diene of each B block is also independently selected from isoprene and butadiene with butadiene being the most preferred and the mono alkenyl arene is as defined hereinbefore with regard to A, with styrene being the most preferred.

The block copolymers of the present invention may be prepared by any of the methods known in the art, including sequential polymerization and coupling using standard coupling agents. Examples of block copolymers that may be used in the FPPP of the present invention, as well as the methods of preparing such block copolymers, include but are not limited to: polymers and methods disclosed in U.S. Pat. No. 4,925,899, U.S. Pat. No. 6,521,712, U.S. Pat. No. 6,420,486, U.S. Pat. No. 3,369,160, U.S. Pat. No. 6,265,485, U.S. Pat. No. 6,197,889, U.S. Pat. No. 6,096,828, U.S. Pat. No. 5,705,569, U.S. Pat. No. 6,031,053, U.S. Pat. No. 5,910,546, U.S. Pat. No. 5,545,690, U.S. Pat. No. 5,436,298, U.S. Pat. No. 4,248,981, U.S. Pat. No. 4,167,545, U.S. Pat. No. 4,122,134, U.S. Pat. No. 6,593,430, and U.S. patent application Ser. No. 10/359,981, each incorporated herein by reference.

As noted hereinbefore, the block copolymers used in the present invention have at least two A blocks and at least one B block. Accordingly, the block copolymers used in the present invention may comprise any block copolymer which meets the criteria for the present invention, including block copolymers that are linear sequential, as well as block copolymers that are coupled (including linear coupled and branched (multi-arm) coupled block copolymers). When the block copolymer is linear coupled or multi-arm coupled, the arms may be symmetrical or asymmetrical.

While not wishing to be bound by the structure of the present block copolymers, representative structures which contain at least two A blocks and at least one B block and which are considered to be within the scope of the present invention, provided they meet the other criteria noted above, include, but are not limited to, block copolymers of the structure:

(1) (A-A₁-B—C)ₘ—X—(C—B-A₁)ₙ, wherein each A and A₁ is independently a polymer block of mono alkenyl arene, each B is independently a copolymer block of mono alkenyl arene and conjugated diene, each C is independently a block of conjugated diene and m<n and m+n is 3 to 20.

(2) A₁-B₁-B₂-A₂, wherein each A₁ and A₂ is independently a polymer block of mono alkenyl arene and each of B₁ and B₂ is independently a polymer block of mono alkenyl arene and conjugated diene.

(3) A-B-A, (A-B)ₙ, (A-B)ₙ-A, (A-B-A)ₙ—X, or (A-B)ₙ—X, wherein each A is independently a polymer block of mono alkenyl arene, each B is independently a polymer block of mono alkenyl arene and conjugated diene, X is the residue of a coupling agent and n is from 2 to 30.

(4) A-A₁-B—B₁—X—B₁—B-A₁-A, A-B—B₁—X—B-A, A-A₁-B—B₁—X—B₁—B-A, wherein each A and A₁ is independently a polymer block of mono alkenyl arene and each B and B₁ is independently a polymer block of mono alkenyl arene and conjugated diene

(5) B—(A-B)ₙ; X—[(A-B)ₙ]ₘ₊₁; X—[(B-A)ₙ]ₘ₊₁; X—[(A-B)ₙ-A]_{m +1}; X—[(B-A)ₙ—B)]ₘ₊₁; Y-[(A-B)ₙ]ₘ₊₁; Y—[(B-A)ₙ]ₘ₊₁; Y—[(A-B)ₙ-A]ₘ₊₁; Y—[(B-A)ₙ-B]ₘ₊₁ wherein each A is independently a polymer block of mono alkenyl arene, each B is independently a polymer block of mono alkenyl arene and conjugated diene, X is a radical of an n-functional initiator, Y is a radical of an m-functional coupling agent and m and n are whole numbers from 1 to 10.

(6) (A₁-A₂-B₁—B₂—B₃)ₙ—X—(B₃—B₂—B-A₂)ₘ wherein each A₁ and A₂ is independently a polymer block of mono alkenyl arene, each B₁, B₂ and B₃ is independently a polymer block of mono alkenyl arene and conjugated diene and n and m are each independently 0 or >3.

(7) A-A₁-B—X—B-A₁-A, A-B—X—B-A, A-A₁-B—X—B-A wherein each A is independently a polymer block of mono alkenyl arene and each B is independently a polymer block of mono alkenyl arene and conjugated diene.

(8) A₁-B₁—C₁, A₁-C₁—B₁, A₁-B₁—C₁-A₂, A₁-B₁—C₁—B₂-A₂, A₁-C₁—B₁—C₂-A₂, A₁-B₁—B₂—C₁-A₂, A₁-B₁—C₁—B₂—C₂—B₃-A₂, A₁-B₁-A₂-B₂—C₁-A₃, A₁-B₁—C₁-A₂-C₂—B₂-A₃, A₁-B₁-A₂-C ₁—B₂, A₁-B₁-A₂-B₂—C₁, wherein each A₁, A₂ and A₃ is independently a mono alkenyl arene, each B₁ and B₂ is independently a polymer block of mono alkenyl arene and conjugated diene and each C₁ and C₂ is independently a polymer block of conjugated diene.

With regard to the above-noted structures specifically made by coupling, those skilled in the art will recognize that these polymers may contain a small amount of diblock (i.e., up to about 10% diblock).

As used herein, in those instances where it is noted that the blocks are “independently” a polymer block, such polymer blocks can be the same, or they can be different.

Also contemplated within this scope are various types of block copolymers that are grafted or functionalized with various functional groups such as unsaturated monomer having one or more functional groups or their derivatives, such as carboxylic acid groups and their salts, anhydrides, esters, imide groups, amide groups, and acid chlorides. The preferred monomers to be grafted onto the block copolymers are maleic anhydride, maleic acid, fumaric acid, and their derivatives. A further description of functionalizing such block copolymers can be found in U.S. Pat. No. 4,578,429 and U.S. Pat. No. 5,506,299. In another manner, the copolymers employed in the present invention may be functionalized by grafting silicon or boron-containing compounds to the polymer as taught, for example, in U.S. Pat. No. 4,882,384. In still another manner, the block copolymers of the present invention may be contacted with an alkoxy-silane compound to form silane-modified block copolymer. In yet another manner, the block copolymers of the present invention may be functionalized by reacting at least one ethylene oxide molecule to the polymer as taught in U.S. Pat. No. 4,898,914, or by reacting the polymer with carbon dioxide as taught in U.S. Pat. No. 4,970,265. Still further, the block copolymers of the present invention may be metallated as taught in U.S. Pat. No. 5,206,300 and U.S. Pat. No. 5,276,101, wherein the polymer is contacted with an alkali metal alkyl, such as a lithium alkyl. And still further, the block copolymers of the present invention may be functionalized by grafting sulfonic groups to the polymer as taught in U.S. Pat. No. 5,516,831.

It should be noted that the above-described unsaturated block copolymers used in the present invention may, if desired, be readily prepared by the methods set forth above. However, since many of these copolymers are commercially available, it is usually preferred to employ the commercially available polymer as this serves to reduce the number of processing steps involved in the overall process. Examples of the above block copolymers which are commercially available include, but are not limited to, Styrolux®3G55 (commercially available from BASF Aktiengesellschaft), XK40 (commercially available from Chevron-Phillips Corporation) and KRATONO® MD 6459 (commercially available from KRATON Polymers LLC).

The above-discussed copolymers are advantageously employed as a component of the FPPP composition of the present application. Although the invention is independent of any theory explaining its operation, it is believed that the high mono alkenyl arene concentration provides a stronger, more abrasion resistant flexographic printing plate. Moreover, the lower concentration of conjugated diene reduces the unsaturated double bond concentration in the block copolymer, decreasing the vulnerability of the block copolymer to degradation by ozone.

The block copolymer of the formulation is present in an amount from about 50% to about 80% by weight based on the total weight of said flexographic printing plate precursor composition, preferably from about 60% to about 65% by weight.

The second component of the FPPP composition is a plasticizer. Because the block copolymer of the present invention is distinguished from the block copolymers of FPPP compositions of the prior art so too is the plasticizer of the FPPP composition of the present invention. In the past, plasticizers, if present, were hydrocarbon oils which were compatible with the block copolymers employed in prior art FPPP compositions, e.g., photo-curable block copolymer-containing compositions. Although the present invention is independent of any theory explaining its operation, it is believed that the compatible use of hydrocarbon oils as plasticizers for the block copolymers of the prior art employed as FPPP compositions was predicated upon the higher conjugated diene concentration of those block copolymers. Indeed, block copolymers employed in prior art FPPP compositions which included low mono alkenyl arene concentration, e.g., less than about 20%, oftentimes included no plasticizer.

The inclusion of a plasticizer, in the higher mono alkenyl arene concentration block copolymers of the present invention, is necessary to provide the requisite flexibility. This flexibility can be indirectly measured by the hardness of the resultant FPPP composition. The Shore hardness, in order to meet flexibility requirements of the resultant flexible printing plate, should be no higher than about 70, preferably no higher than about 66.

As stated above, plasticizers within the contemplation of the present invention must be compatible with the high mono alkenyl arene concentration block copolymer of the FPPP composition. To that end, plasticizers within the scope of the present FPPP composition are aromatic liquids. Preferred aromatic liquids include aromatic esters and liquid aromatic resins.

In the embodiment wherein the plasticizer is an aromatic ester, it is preferred that the aromatic ester be a benzoate or a phthalate compound. Particularly preferred species of such esters include butyl benzyl phthalate, isodecyl benzoate and 2,2,4-trimethyl pentanediol dibenzoate.

In the embodiment wherein the plasticizer is a liquid aromatic resin, the plasticizer is a polymer made with aromatic monomers whose softening point is lower than ambient temperature. A particularly preferred class of liquid aromatic resins is the class of aromatic hydrocarbon resins whose softening point is about 5° C. or lower.

In the composition of the present invention, the plasticizer is present in an amount from about 10% to about 40% by weight based on the total weight of said flexographic printing plate precursor composition, preferably from about 22% to about 28% by weight.

The third component of the FPPP composition is a crosslinker. Suitable crosslinkers are known to those skilled in the art and include, but are not limited to, acrylic crosslinking compounds selected from monounsaturated or polyunsaturated monomers, such as e.g., esters or amides of acrylic acid or methacrylic acid with monofunctional or polyfunctional alcohols, amines, aminoalcohols and hydroxyethers or hydroxyesters. Also suitable are mixtures of monounsaturated and polyunsaturated compounds, as described in DE-C-3744243 and DE-A-3630474. More specific examples of addition polymerizable compounds are butyl acrylate, isodecyl acrylate, 1,6-hexanediol diacrylate (HDDA), 1,6-hexanediol dimethacrylate, trimethylolpropane triacrylate and dipentaerythritol monohydroxypentacrylate. The preferred acrylic crosslinkers are 1,6-hexanediol diacrylate, 1,6-hexanediol dimethacrylate and trimethylolpropane triacrylate.

The preferred amount of crosslinker is from about 2% to about 50% by weight based on the total weight of the flexographic printing plate precursor composition. The more preferred amount of crosslinker is from about 3% to about 30% by weight and the most preferred amount is from about 5% to about 15% by weight.

The fourth component of the FPPP composition is a photoinitiator. Photoinitiators are known to those skilled in the art and examples of suitable photoinitiators have been disclosed in European patent specification No. 0 696 761 and U.S. Pat. No. 4,894,315; U.S. Pat. No. 4,460,675 and U.S. Pat. No. 4,234,676, each incorporated herein by reference. Typically, the photoinitiator is selected from optionally substituted polynuclear quinones, aromatic ketones, benzoin and benzoin ethers and 2,4,5-triarylimidazolyl dimers.

Preferred photoinitiators are selected from the group consisting of:

(1) a benzophenone of the general formula (I) 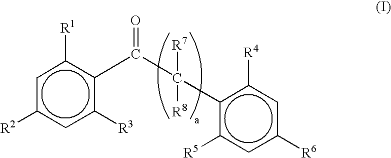
wherein R¹ to R⁶ independently represent hydrogen or an alkyl group having from 1 to 4 carbon atoms, preferably methyl, and wherein R⁷ and/or R⁸ have the same meaning as R¹ to R⁶ or represent an alkoxy group of 1 to 4 carbon atoms and wherein a has a value of 0, 1, or 2, optionally in combination with at least one tertiary amine;

(2) a sulphur-containing carbonyl compound, wherein the carbonyl group is directly bound to at least one aromatic ring and is preferably of the general formula 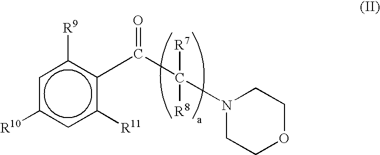
wherein R⁹, R¹⁰, and R¹¹ each may represent hydrogen, an alkyl of 1 to 4 carbon atoms, or an alkylthio having 1 to 4 carbon atoms, and R⁷ and R⁸ have the same meanings given above; and

(3) mixtures of the photoinitiators represented by the formulas in categories (1) and (2).

Examples of suitable compounds of category (1) are benzophenone, 2,4,6-trimethylbenzophenone, 4-methylbenzophenone and a eutectic mixture of 2,4,6-trimethylbenzophenone and 4-methoylbenzophenone (ESACURE® TZT) and 2,2-dimethoxy-1,2-diphenylethan-1-one (IRGACURE® 651) (ESACURE® and IRGACURE® are trade marks). These compounds may be employed in combination with tertiary amines, such as, e.g., UVECRYL® 7100 (UVECRYL® is a trade mark).

Category (2) embraces compounds such as, e.g., 2-methyl-1-[4-(methylthio)phenyl]-2-morpholino-propanone-1, commercially available as IRGACURE® 907.

An example of suitable mixtures (category (3)) is a mixture of 15% by weight of a mixture of 2-isopropylthioixanthone and 4-isopropylthioxanthone, and 85% by weight of a mixture of 2,4,6-trimethylbenzophenone and 4-methyl-benzophenone. This mixture is commercially available under the trade name ESACURE® X15.

In a preferred embodiment of the present invention, the photoinitiator is selected from the group consisting of (i) benzophenone, (ii) a mixture of benzophenone and a tertiary amine containing a carbonyl group which is directly bonded to at least one aromatic ring, (iii) 2-methyl-1-[4-(methylthio)phenyl]-2-morpholinopropanone-1 (IRGACURE® 907), (iv) 2,2-dimethoxy-1,2-diphenylethan-1-one (IRACURE® 651), of which (iii) and (iv) are most preferred.

In the composition of the present invention, the photoinitiator is present in an amount from about 0.5% to about 4% by weight based on the total weight of said flexographic printing plate precursor composition, preferably from about 1% to about 2% by weight.

In addition to the above essential components, the FPPP composition may be modified further with the addition of other polymers, fillers, antioxidants, stabilizers, fire retardants, anti blocking agents, pigments, slip agents, lubricants and other rubber compounding ingredients without departing from the scope of this invention. When one or more of such other components are present in the FPPP compositions of the present invention, they will typically be present in a total amount from about 0.05 weight percent to about 1.5 weight percent based on the total weight percent of the combined components in the FPPP composition.

The FPPP compositions are formulated using techniques well known in the art including, for example, blending of the various components together in a suitable mixer. Molding is achieved utilizing conventional molding processing that is also well known in the art.

The following examples are given to illustrate the invention of the present application. Because these examples are given for illustrative purposes only, the invention should not be deemed limited thereto.

The following materials were used in the examples below.

Copolymer 1: An unsaturated block copolymer having a modulus of about 73,000 psi and a polystyrene content of about 75% by weight, commercially available from KRATON Polymers LLC as KRATON® MD6459.

KRATON® D1114: Styrene-isoprene-styrene (S-I-S) block copolymer containing 18% S by weight supplied by KRATON Polymers LLC.

KRATON® D1155: Polystyrene-polybutadiene-polystyrene (S-B-S) block copolymer containing 40% S by weight supplied by KRATON Polymers LLC.

Benzoflex® 131: Isodecyl benzoate aromatic ester plasticizer supplied by Velsicol.

Santicizer® 160: Butyl benzyl phthalate aromatic ester plasticizer supplied by Ferro.

Irgacure® 651: Benzyl dimethyl ketal photoinitiator supplied by Ciba.

Sartomer® SR238: Hexanediol diacrylate crosslinker supplied by Sartomer.

Irganox® 1010: Phenolic antioxidant supplied by Ciba.

### EXAMPLE 1

### Compatibility of Block Copolymer 1 with Aromatic Ester Plasticizers

Copolymer 1 was tested to determine its compatibility with aromatic esters. To that end Benzoflex® 131 and Santicizer® 160 were combined with Co polymer 1 as a solution in toluene and poured into molds. The toluene solvent was driven off to yield 2.5 mm thick dry films which were evaluated qualitatively. The results of this evaluation of 5 compositions prepared in accordance with this example are set forth in Table 1.

TABLE 1

| Component, | Composition | | | | |
|---|---|---|---|---|---|
| % by Wt | A | B | C | D | E |
| Copolymer 1 | 100 | 75 | 50 | 75 | 50 |
| Benzoflex ® 131 | 0 | 25 | 50 | 0 | 0 |
| Santicizer ® 160 | 0 | 0 | 0 | 25 | 50 |
| Appearance¹ | Hard, | Flexible, | Tacky, | Flexible, | Tacky, |
| | Stiff | Strong | transfers | Strong | transfers |

¹Of 2.5 mm thick film.

Results show that the aromatic ester plasticizers have good compatibility with Copolymer 1 and that they can be used at up to about 50% before they soften the polymer excessively.

### EXAMPLE 2

### Preparation of FPPP Compositions of the Present Invention, the Prior Art and Outside the Present Invention

Two FPPP compositions of the prior art, denoted as PA1 and PA2, were prepared utilizing conventional block copolymers. PA1 used an SIS polymer having 18% styrene, and PA2 used an SBS polymer having 40% styrene. In addition, three FPPP compositions utilizing block Copolymer 1 within the scope of the present invention were prepared. One of the FPPP compositions, denoted CE1, was prepared in the absence of a plasticizer. A second of these compositions, denoted as 1, utilized an aromatic ester plasticizer, 2,2,4-trimethyl pentanediol dibenzoate, in a concentration of 10%, based on the total weight of the composition. Finally, the third prepared FPPP composition, utilizing block Copolymer 1, within the scope of the present invention, denoted as 2, utilized the same 2,2,4-trimethyl pentanediol dibenzoate plasticizer in a concentration of 25% by weight.

Each of the five FPPP compositions was prepared by mixing the components in toluene (25% by weight). The resultant solution was poured into a mold made of 25 micron Mylar polyester film. The toluene was driven off slowly, yielding 2.2 mm thick plates. The plates were cured in a Model CL-1000 irradiation unit (from UVP, Inc., Upland, Calif.) equipped with five 8-watt UV-A bulbs by irradiating the plates for 5 minutes on each side.

The resultant printing plates were removed from the Mylar backing for testing. Hardness was tested according to ASTM D2240. Gel contents were measured on 2.5 cm disks which were cut from the photocured films. The disks were initially weighed and then immersed in toluene for four days to extract any uncured fraction. The swollen disks were then dried to remove toluene and then weighed. The gel content was calculated as the percentage of the original photocured composition which was insoluble in toluene, excluding from the calculation the components which cannot become incorporated into the gel (Shellflex® 371, Benzoflex® 354, and Irganox® 1010).

A summary of each of the compositions, as well as the analysis of the plates, is provided in Table 2.

TABLE 2
COMPOSITION NO.

| Component, % by | | | | | |
|---|---|---|---|---|---|
| Wt. | PA1 | PA2 | CE1 | 1 | 2 |
| KRATON ® D1114 | 87.7 | 0 | 0 | 0 | 0 |
| KRATON ® D1155 | 0 | 62.7 | 0 | 0 | 0 |
| Copolymer 1 | 0 | 0 | 87.7 | 77.7 | 62.7 |
| Sartomer ® SR238 | 10.5 | 10.5 | 10.5 | 10.5 | 10.5 |
| Shellflex ® 371 | 0 | 25.0 | 0 | 0 | 0 |
| Benzoflex ® 354 | 0 | 0 | 0 | 10.0 | 25.0 |
| Irgacure ® 651 | 1.3 | 1.3 | 1.3 | 1.3 | 1.3 |
| Irganox ® 1010 | 0.4 | 0.4 | 0.4 | 0.4 | 0.4 |

Cured Properties

| | | | | | |
|---|---|---|---|---|---|
| Hardness, | 64 | 61 | 86 | 64 | 61 |
| 10 sec Shore A | | | | | |
| Gel Content, % | 97 | 94 | 94 | 95 | 94 |

### Discussion of Results

The composition CE1, which is outside the scope of the FPPP composition in that it does not include a plasticizer, although successfully crosslinked by photo-initiation, as evidenced by its high gel content, produced a hardness far in excess of that permitted to provide the flexibility required of a flexible printing plate.

The compositions PA1 and PA2 represented fabrication of FPPP compositions utilizing a block copolymer having high conjugated diene concentration which produces printing plates having good flexibility properties as evidenced by lower Shore hardness. Indeed composition PA1, containing an S-I-S copolymer, did not require a plasticizer insofar as it only includes 18% styrene. It produced the requisite crosslinkage, as established by its gel content, as well as providing reasonable flexibility, as indicated by its Shore hardness of 64.

The second prior art block copolymer, composition PA2 containing an S-B-S copolymer, produced, in the presence of a compatible hydrocarbon oil plasticizer, a good crosslinking FPPP composition that provides excellent flexibility as established by its Shore hardness of 61.

Compositions 1 and 2, prepared in accordance with the FPPP composition of the present invention, produced compositions having good curing characteristics and as good flexibility as that attained by prior art compositions, e.g., PA2, as evidenced by their excellent Shore hardness of 64 and 61. However, unlike compositions of the prior art, such as PA2, the block copolymer of Composition 1 contains a far lower concentration of conjugated diene. As such, unlike the prior art compositions, Compositions PA1 and PA2, which produced printing plates which were flexible and elastic, the plate prepared from Compositions 1 and 2 were flexible but not as elastic. That is, while the plates produced from Composition PA1 and PA2 when bent or stretched snap back to their original shape, the plates fabricated of the Copolymer 1 when bent or stretched returned more slowly to their original shape.

Another difference between the plates formed of prior art Compositions PA1 and PA2 and Compositions 1 and 2, formed of Copolymer 1, is that the plates formed of the prior art compositions had a higher coefficient of friction. This difference in coefficient of friction was readily apparent from the feel of the plates as they were being handled. It is expected that the lower coefficient of friction of Compositions 1 and 2 provides a printing plate having better abrasion resistance.

The above embodiments and examples are given to illustrate the scope and spirit of the present invention. These embodiments and examples will make apparent, to those skilled in the art, other embodiments and examples. These other embodiments and examples are within the contemplation of the present invention. Therefore, the present invention should be limited only by the appended claims.

What is claimed is:

1. A flexographic printing plate precursor composition comprising:
(i) from about 50% to about 80% of at least one unsaturated block copolymer, wherein:
(1) said block copolymer having a mono alkenyl arene content equal to or greater than 60 weight percent, based on the total weight of the block copolymer;
(2) said block copolymer having a modulus less than 125,000 psi; and
(3) said block copolymer comprises at least two A blocks and at least one B block, each A block independently selected from mono alkenyl arene polymer blocks and each B block independently selected from
(a) polymer blocks having at least one conjugated diene and at least one mono alkenyl arene and having a random distribution;
(b) polymer blocks having at least one conjugated diene and at least one mono alkenyl arene and having a blocked distribution;
(c) polymer blocks having at least one conjugated diene and at least one mono alkenyl arene and having a tapered distribution; and
(d) polymer blocks having at least one conjugated diene and at least one mono alkenyl arene and having a controlled distribution;
(ii) from about 10% to about 40% of an aromatic liquid plasticizer;
(iii) from about 5% to about 15% of an acrylic or methacrylic crosslinker; and
(iv) from about 0.5% to about 4% of a photoinitiator,
said percentages of components (i), (ii), (iii) and (iv) being by weight, based on the total weight of said flexographic printing plate precursor composition.

2. The composition of claim 1 wherein in each B block, the mono alkenyl arene comprises styrene and the conjugated diene comprises butadiene, isoprene, or mixtures thereof.

3. The composition of claim 2 wherein each B block has a random distribution.

4. The composition of claim 2 wherein each B block has a blocked distribution.

5. The composition of claim 2 wherein each B block has a tapered distribution.

6. The composition of claim 2 wherein each B block has a controlled distribution.

7. The composition of claim 1 wherein said mono alkenyl arene content is from about 60 to about 80 weight percent, based on the total block copolymer.

8. The composition of claim 1 wherein said block copolymer is linear coupled or multi-arm coupled having symmetrical arms.

9. The composition of claim 1 wherein said block copolymer is linear coupled or mult-arm coupled having unsymmetrical arms.

10. The composition of claim 1 wherein said component (ii) is selected from the group consisting of aromatic esters and liquid aromatic resins.

11. The composition of claim 1 wherein said component (iii) is selected from the group consisting of 1,6-hexanediol diacrylate, 1,6-hexanediol dimethacrylate and trimethylolpropane triacrylate.

12. The composition of claim 1 wherein said component (iv) is selected from the group consisting of benzophenone, mixtures of benzophenone and tertiary amines containing a carbonyl group directly bonded to at least one aromatic ring, 2-methyl-1-[4-(methylthio)phenyl]-2-morpholinopropanone, and 2,2-dimethoxy-1,2-diphenylethane-1-one.

13. A printing plate comprising the photo-cured product of said composition of claim 2.

14. A printing plate comprising the photo-cured product of said composition of claim 3.

15. A printing plate comprising the photo-cured product of said composition of claim 4.

16. A printing plate comprising the photo-cured product of said composition of claim 5.

17. A printing plate comprising the photo-cured product of said composition of claim 6.

18. A printing plate comprising the photo-cured product of said composition of claim 8.

19. A printing plate comprising the photo-cured product of said composition of claim 9.
